(19) United States
(12) Patent Application Publication
(10) Pub. No.: US 2010/0326901 A1
(43) Pub. Date: Dec. 30, 2010

(54) PRESSURE VESSEL FOR MEMBRANE ELEMENT, MEMBRANE FILTRATION APPARATUS EQUIPPED WITH THE PRESSURE VESSEL FOR MEMBRANE ELEMENT, AND METHOD FOR MANUFACTURING MEMBRANE FILTRATION APPARATUS

(75) Inventors: Shinichi Chikura, Osaka (JP); Toshimitsu Hamada, Osaka (JP); Masashi Beppu, Osaka (JP); Yasuhiro Uda, Osaka (JP); Masakatsu Takata, Osaka (JP)

Correspondence Address: KNOBBE MARTENS OLSON & BEAR LLP, 2040 MAIN STREET, FOURTEENTH FLOOR, IRVINE, CA, 92614, US

(73) Assignee: NITTO DENKO CORPORATION

(21) Appl. No.: 12/918,163

(22) PCT Filed: Feb. 20, 2009
(86) PCT No.: PCT/JP2009/053065

§ 371 Date: Aug. 18, 2010

(30) Foreign Application Priority Data
Feb. 21, 2008 (JP) 2008-039796

(51) Int. Cl. B01D 63/00; B01D 63/10; C02F 1/44; B23P 17/04

(52) U.S. Cl. 210/321.64; 210/321.6; 29/428

(57) ABSTRACT

Provided are a pressure vessel for a membrane element in which the membrane element can be easily mounted, a membrane filtration apparatus equipped with the pressure vessel for a membrane element, and a method for manufacturing a membrane filtration apparatus. A rail (protrusion) 60 is formed on the inner circumferential surface of the pressure vessel 40 in such a manner that a ridge line 61 extends along the insertion direction of the membrane element. Consequently, the membrane element 10 can be inserted into the pressure vessel 40 so as to be in a sliding contact onto the ridge line 61 of the rail 60 formed on the inner circumferential surface of the pressure vessel 40. Therefore, the frictional resistance can be reduced as compared with conventional ways, so that the membrane element 10 can be easily mounted onto the pressure vessel 40.

### TECHNICAL FIELD

The present invention relates to a pressure vessel for a membrane element that houses the membrane element for separating or purifying gas or liquid with a separation membrane, a membrane filtration apparatus equipped with the pressure vessel for a membrane element, and a method for manufacturing a membrane filtration apparatus.

### BACKGROUND ART

As the membrane element, there is known, for example, a spiral-type membrane element in which a plurality of separation membranes and flow path materials are wound around a core tube and which is used for desalination of sea water or production of ultrapure water. Such a membrane element is used as a membrane filtration apparatus that is constructed by arranging a plurality of membrane elements in a line and connecting the core tubes of adjacent membrane elements with each other by an interconnector (connection section). A plurality of membrane elements connected in this manner are housed, for example, in a tubular pressure vessel formed with resin and treated as one membrane filtration apparatus (refer to, for example, Patent Document 1 or 2).

FIG. 15 is a cross-sectional view illustrating an internal construction when a membrane element 110 is inserted into a pressure vessel 140 in a conventional membrane filtration apparatus 150. Also, FIG. 16 is a cross-sectional view of the membrane filtration apparatus 150 taken along line D-D shown in FIG. 15. This membrane filtration apparatus 150 is formed by arranging a plurality of membrane elements 110 in a line and connecting them in the pressure vessel 140.

A circular end member 130 that accords to an end surface shape of the membrane element 110 is mounted at both ends of each membrane element 110. This end member 130 functions as a seal carrier that holds a sealing member (not illustrated) on an outer circumferential surface thereof and also functions as a telescope prevention member that prevents telescopic deformation of a membrane member 116 that is wound around the core tube 120.

### PRIOR ART DOCUMENTS

Patent Document 1: Japanese Unexamined Patent Publication No. 2007-190547
Patent Document 2: Japanese Unexamined Patent Publication No. 11-267469

### DISCLOSURE OF THE INVENTION

### Problems to be Solved by the Invention

In the case of a conventional construction such as described above, as shown in FIGS. 15 and 16, the lower part of each membrane element 110 at the outer circumferential surface is brought into a sliding contact with the inner circumferential surface of the pressure vessel 140. Therefore, as the mass of the membrane element increases, and as the outer diameter of each membrane element 110 and the inner diameter of the pressure vessel 140 increase, the contact area of these will be larger to increase the frictional resistance, making it difficult to mount the membrane element 110 with manual work.

In particular, in recent years, there is an increasing number of large-scale plants that can process a larger amount of raw liquid (for example, raw water such as waste water or sea water). Also, the membrane elements are coming to have a larger scale so as to be capable of performing a more efficient process. Conventionally, a membrane filtration apparatus in which the outer diameter of the membrane element is 8 inches has been prevalent. However, in recent years, a membrane filtration apparatus in which the outer diameter of the membrane element is 16 inches has appeared, so that the scale is on the road of increase.

In a large-scale membrane filtration apparatus as described above, by increase of the weight of each membrane element, it will be difficult to mount the membrane elements, and moreover, the frictional resistance will be larger by increase of the contact area with the inner circumferential surface of the pressure vessel as described above, making it further difficult to mount the membrane elements.

The present invention has been made in view of the foregoing circumstances, and an object thereof is to provide a pressure vessel for a membrane element in which the membrane element can be easily mounted, a membrane filtration apparatus equipped with the pressure vessel for a membrane element, and a method for manufacturing a membrane filtration apparatus.

### Means for Solving the Problems

A pressure vessel for a membrane element according to the present invention relates to the pressure vessel for a membrane element into which the membrane element is inserted through one open end, wherein an inner circumferential surface of the pressure vessel is subjected to a frictional resistance reduction process that reduces a frictional resistance between the membrane element inserted into the pressure vessel and the inner circumferential surface when the membrane element is inserted.

With such a construction, the membrane element can be inserted into the pressure vessel so as to be in a sliding contact with the inner circumferential surface of the pressure vessel that has been subjected to a frictional resistance reduction process. Therefore, the frictional resistance can be reduced as compared with a conventional construction, so that the membrane element can be easily mounted onto the pressure vessel. The frictional resistance reduction process as referred to herein is not particularly limited as long as it produces a friction reduction effect; however, it refers, for example, to disposing at least one of a protrusion or recess, a member having a high sliding property, and a rotor, or two or more of these in combination on the inner circumferential surface of the pressure vessel.

A pressure vessel for a membrane element according to the present invention relates to the pressure vessel for a membrane element, wherein the frictional resistance reduction process is intermittently performed in a direction of inserting the membrane element.

With such a construction, the frictional resistance upon insertion of the membrane element into the pressure vessel can be reduced, so that the membrane elements can be easily mounted onto the pressure vessel. Also, by intermittently performing the frictional resistance reduction process in a direction of inserting the membrane element, the sealing member disposed on the end member of the membrane element can be disposed at a stable position and can be let to function effectively, whereby the stability at the time of fixing and at the time of using the membrane element can be raised.

A pressure vessel for a membrane element according to the present invention relates to the pressure vessel for a membrane element, wherein the frictional resistance reduction process is linearly performed in a direction of inserting the membrane element.

With such a construction, by linearly performing the frictional resistance reduction process in a direction of inserting the membrane element, the resistance can be efficiently reduced, whereby the efficiency at the time of mounting the membrane element can be raised.

A pressure vessel for a membrane element according to the present invention relates to the pressure vessel for a membrane element, wherein the frictional resistance reduction process is providing a recess or a protrusion for reducing a contact area to the membrane element on the inner circumferential surface of the pressure vessel.

With such a construction, by providing a recess or a protrusion on the inner circumferential surface of the pressure vessel, the contact area between the inner circumferential surface and the membrane element can be reduced, and the frictional resistance can be effectively reduced, whereby the membrane element can be easily mounted onto the pressure vessel.

A pressure vessel for a membrane element according to the present invention relates to the pressure vessel for a membrane element, wherein at least one ridge line that is brought into contact with the membrane element at the recess or protrusion extends along the direction of inserting the membrane element.

With such a construction, the membrane element can be inserted into the pressure vessel so as to be in a sliding contact with the ridge line of the recess or protrusion formed on the inner circumferential surface of the pressure vessel. Therefore, the contact area between the inner circumferential surface of the pressure vessel and the membrane element can be reduced, and the frictional resistance can be further more effectively reduced, whereby the membrane element can be easily mounted onto the pressure vessel.

A pressure vessel for a membrane element according to the present invention relates to the pressure vessel for a membrane element, wherein at least one protrusion that is brought into contact with the membrane element is further provided on a bottom surface of the recess.

With such a construction, the membrane element can be inserted into the pressure vessel so as to be in a sliding contact with the protrusion in the recess formed on the inner circumferential surface of the pressure vessel, thereby further producing a friction reduction effect.

A pressure vessel for a membrane element according to the present invention relates to the pressure vessel for a membrane element, wherein the frictional resistance reduction process is providing a rotor on the inner circumferential surface of the pressure vessel.

A pressure vessel for a membrane element according to the present invention relates to the pressure vessel for a membrane element, wherein the frictional resistance reduction process is fixing a member having a higher sliding property than the inner circumferential surface of the pressure vessel.

With these constructions, by providing a rotor that rotates in contact with the membrane element or by fixing a member having a higher sliding property than the inner circumferential surface of the pressure vessel on the inner circumferential surface of the pressure vessel, the frictional resistance between the inner circumferential surface and the membrane element can be effectively reduced, whereby the membrane element can be easily mounted onto the pressure vessel.

A pressure vessel for a membrane element according to the present invention relates to the pressure vessel for a membrane element, wherein the membrane element is a cylindrical spiral-type membrane element in which a plurality of reverse osmosis membranes, a feed side flow path material, and a permeate side flow path material in a laminated state are wound around a core tube.

A membrane filtration apparatus according to the present invention relates to the membrane filtration apparatus equipped with the pressure vessel for a membrane element.

A method for manufacturing a membrane filtration apparatus according to the present invention relates to the method for manufacturing a membrane filtration apparatus, wherein a membrane element is mounted onto an inside of a pressure vessel while bringing the membrane element into contact with a part of an inner circumferential surface of the pressure vessel that has been subjected to a frictional resistance reduction process.

### Effects of the Invention

According to the present invention, the membrane element can be inserted into the pressure vessel so as to be in a sliding contact with the inner circumferential surface of the pressure vessel that has been subjected to a frictional resistance reduction process, whereby the frictional resistance can be reduced, and the membrane element can be easily mounted onto the pressure vessel.

### BRIEF DESCRIPTION OF THE DRAWINGS

FIG. 1 is a schematic cross-sectional view illustrating one example of a membrane filtration apparatus equipped with a pressure vessel for a membrane element.

FIG. 2 is a perspective view illustrating an exemplary internal construction of the membrane element of FIG. 1.

FIG. 3 is a cross-sectional view illustrating an internal construction when the membrane element is inserted into the pressure vessel in a membrane filtration apparatus equipped with a pressure vessel for a membrane element according to a first embodiment of the present invention.

FIG. 4 is a cross-sectional view of the membrane filtration apparatus taken along line A-A shown in FIG. 3.

FIG. 5A is a partial cross-sectional view of a membrane filtration apparatus showing a first modified example of a protrusion.

FIG. 5B is a partial cross-sectional view of a membrane filtration apparatus showing a second modified example of a protrusion.

FIG. 5C is a partial cross-sectional view of a membrane filtration apparatus showing a third modified example of a protrusion.

FIG. 6 is a cross-sectional view illustrating an internal construction when the membrane element is inserted into the pressure vessel in a membrane filtration apparatus equipped with a pressure vessel for a membrane element according to a second embodiment of the present invention.

FIG. 7 is a cross-sectional view of the membrane filtration apparatus taken along line B-B shown in FIG. 6.

FIG. 8 is a cross-sectional view illustrating an internal construction when the membrane element is inserted into the pressure vessel in a membrane filtration apparatus equipped with a pressure vessel for a membrane element according to a third embodiment of the present invention.

FIG. 9 is a cross-sectional view of the membrane filtration apparatus taken along line C-C shown in FIG. 8.

FIG. 10A is a partial cross-sectional view of a pressure vessel showing a first modified example of a recess.

FIG. 10B is a partial cross-sectional view of a pressure vessel showing a second modified example of a recess.

FIG. 10C is a partial cross-sectional view of a pressure vessel showing a third modified example of a recess.

FIG. 11 is a cross-sectional view illustrating an internal construction when the membrane element is inserted into the pressure vessel in a membrane filtration apparatus equipped with a pressure vessel for a membrane element according to a fourth embodiment of the present invention.

FIG. 12 is a cross-sectional view of the membrane filtration apparatus taken along line D-D shown in FIG. 11.

FIG. 13A is a partial cross-sectional view of a membrane filtration apparatus showing a first modified example of a rotor.

FIG. 13B is a partial cross-sectional view of a membrane filtration apparatus showing a second modified example of a rotor.

FIG. 14 is a cross-sectional view illustrating an internal construction when the membrane element is inserted into the pressure vessel in a membrane filtration apparatus equipped with a pressure vessel for a membrane element according to a fifth embodiment of the present invention.

FIG. 15 is a cross-sectional view illustrating an internal construction when the membrane element is inserted into the pressure vessel in a conventional membrane filtration apparatus.

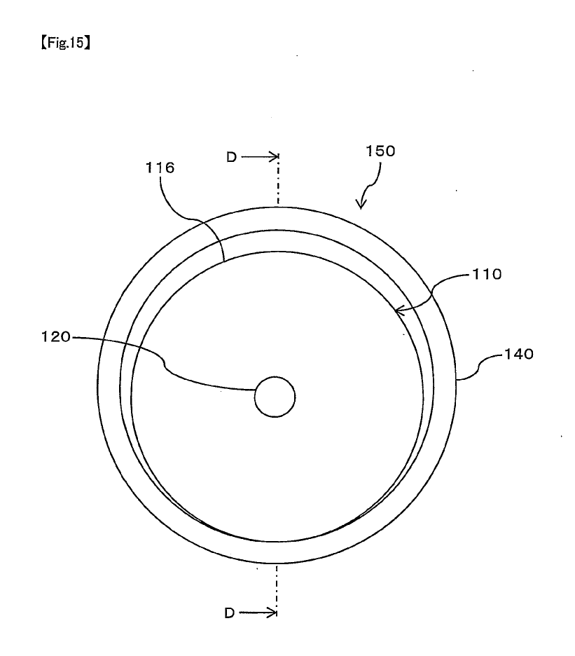

FIG. 16 is a cross-sectional view of the membrane filtration apparatus taken along line D-D shown in FIG. 15.

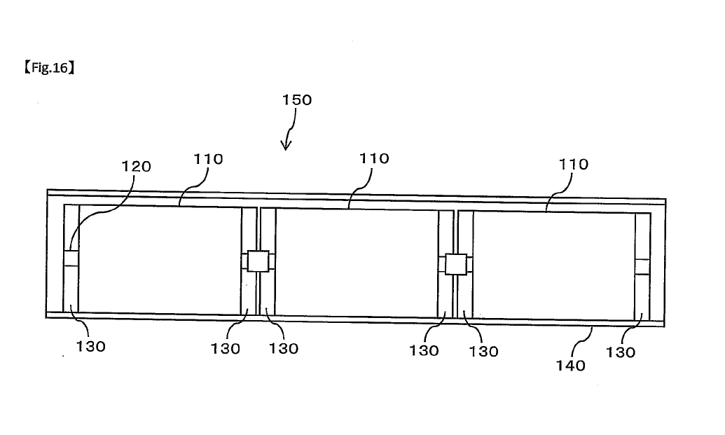

### DESCRIPTION OF REFERENCE NUMERALS

10 membrane element
12 separation membrane
14 permeate side flow path material
16 membrane member
18 feed side flow path material
20 core tube
30 end member
31 sealing member
40 pressure vessel for membrane element
43 opening
50 membrane filtration apparatus
60 rail
61 ridge line
62 recess
70 rail
71 ridge line
72 protrusion
73 groove
81 ridge line
82 protrusion
83 groove
90 roller
91 rotation shaft

### MODES FOR CARRYING OUT THE INVENTION

### First Embodiment

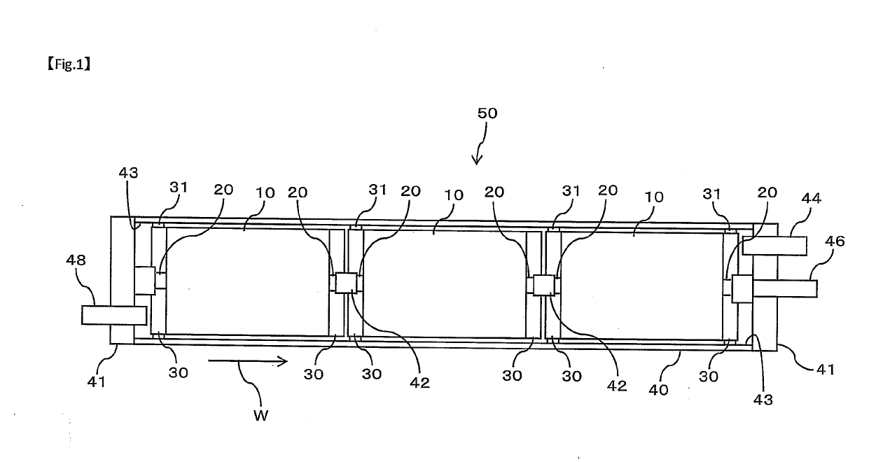

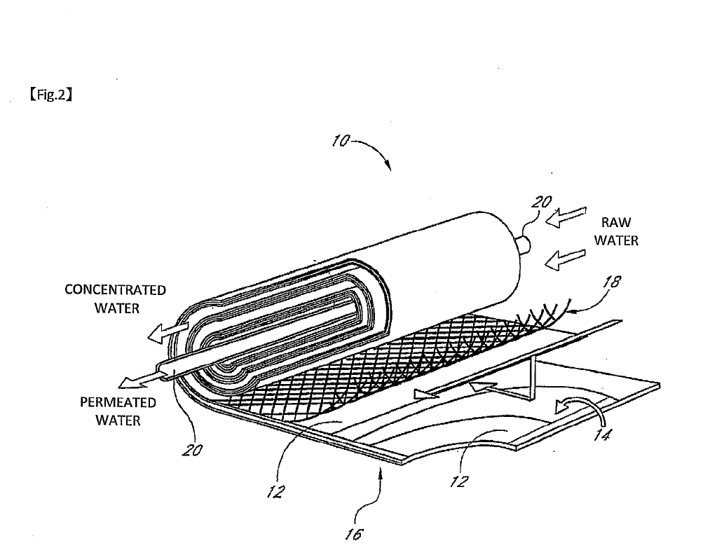

FIG. 1 is a schematic cross-sectional view illustrating one example of a membrane filtration apparatus 50 equipped with a pressure vessel 40 for a membrane element. Also, FIG. 2 is a perspective view illustrating an exemplary internal construction of the membrane element 10 of FIG. 1. This membrane filtration apparatus 50 is constructed by arranging a plurality of membrane elements in a line within the tubular pressure vessel 40 for a membrane element.

The pressure vessel 40 for a membrane element (hereinafter simply referred to as the “pressure vessel 40”) is a cylindrical body made of resin or metal, which is referred to as a pressure-resistant vessel, and is formed, for example, with FRP (Fiberglass Reinforced Plastics). An opening 43 is formed at both ends of the pressure vessel 40, and each opening 43 is closed by mounting a circular vessel cover 41 corresponding to the end surface shape of the pressure vessel 40 onto these openings 43. Each vessel cover 41 is formed, for example, of metal. Here, the pressure vessel 40 is not limited to a cylindrical one, so that the pressure vessel 40 may have a construction formed by another shape such as a tubular shape having a prismatic cross-section; however, the present invention can reduce the friction more effectively as long as the pressure vessel 40 has a cylindrical shape.

A raw water flow inlet 48 through which a raw water (raw liquid) such as waste water or sea water flows in is formed in the vessel cover 41 mounted at one end of the pressure vessel 40. The raw water that flows in through the raw water flow inlet 48 is filtered by a plurality of membrane elements 10 disposed in the pressure vessel 40, whereby a purified permeated water (permeated liquid) and a concentrated water (concentrated liquid), which is a raw water after the filtration, can be obtained. A permeated water flow outlet 46 through which the permeated water flows out and a concentrated water flow outlet 44 through which the concentrated water flows out are formed in the vessel cover 41 mounted at the other end of the pressure vessel 40.

Referring to FIG. 2, the membrane element 10 is an RO (Reverse Osmosis) element that is formed in such a manner that a separation membrane 12, a feed side flow path material 18, and a permeate side flow path material 14 in a laminated state are wound in a spiral form around a core tube 20. However, the membrane element 10 is not limited to a spiral-type membrane element in which a separation membrane 12, a feed side flow path material 18, and a permeate side flow path material 14 are wound in a spiral form, so that the membrane element 10 may be another membrane element such as a membrane element of separation membrane lamination type such as disclosed, for example, in Japanese Unexamined Patent Publication No. 2008-183561.

More specifically, the separation membranes 12 having the same rectangular shape are superposed onto both sides of the permeate side flow path material 14 having a rectangular shape composed of a net-shaped member made of resin, and the three sides thereof are bonded, whereby a bag-shaped membrane member 16 having an opening at one side is formed. Then, the opening of this membrane member 16 is mounted onto the outer circumferential surface of the core tube 20, and is wound around the core tube 20 together with the feed side flow path material 18 composed of a net-shaped member made of resin, whereby the membrane element 10 is formed. The separation membrane 12 is formed, for example, by successively laminating a porous supporter and a skin layer (dense layer) on a non-woven cloth layer.

When a raw water is supplied through one end of the membrane element 10 formed in the above-described manner, the raw water passes within the membrane element 10 via a raw water path formed by the feed side flow path material 18 functioning as a raw water spacer. During this time, the raw water is filtered by the separation membrane 12, and the permeated water that has been filtered from the raw water penetrates into a permeated water flow path formed by the permeate side flow path material 14 functioning as a permeated water spacer.

Thereafter, the permeated water that has penetrated into the permeated water flow path flows to the core tube 20 side by passing through the permeated water flow path, and is guided into the core tube 20 through a plurality of water-passing holes (not illustrated) formed on the outer circumferential surface of the core tube 20. This allows that, through the other end of the membrane element 10, the permeated water flows out via the core tube 20, and the concentrated water flows out via the raw water flow path formed by the feed side flow path material 18.

Referring to FIG. 1, a circular end member 30 corresponding to the end surface shape of the membrane element 10 is mounted at both ends of the membrane element 10. This end member 30 holds a sealing member 31 on the outer circumferential surface thereof, and functions as a seal carrier. Each sealing member 31 is formed to protrude to the outside of the outer circumferential surface of the membrane element 10 by an elastic body such as rubber, and abuts against the inner circumferential surface of the pressure vessel 40, whereby a sealing property is ensured between the membrane elements 10.

Here, in view of ensuring the sealing property between the membrane elements 10, it is sufficient that, to the end members 30 respectively mounted onto the end surfaces of the two opposing membrane elements 10, the sealing member 31 is mounted onto only one of the end members 30 as shown in FIG. 1. However, the present invention is not limited to such a construction, so that it is possible to adopt a construction in which the sealing member 31 is mounted on all the end members 30 mounted on each membrane element 10.

Also, by being mounted at both ends of the membrane element 10, the end member 30 prevents the membrane member 16 wound around the core tube 20 from being shifted in an axial line direction. That is, the end member 30 functions also as a telescope preventing member that prevents telescopic deformation of the membrane member 16 caused by being shifted in an axial line direction.

Referring to FIG. 1, regarding the plurality of membrane elements 10 that are housed within the pressure vessel 40, the core tubes 20 of adjacent membrane elements 10 are connected with each other by a pipe-shaped interconnector (connecting section) 42. Therefore, the raw water that has flowed in through a raw water flow inlet 48 flows into the raw water flow path successively from the membrane element 10 on the raw water flow inlet 48 side, and the permeated water that has been filtered from the raw water by each membrane element 10 flows out through a permeated water flow outlet 46 via one core tube 20 connected by the interconnector 42. On the other hand, the concentrated water that has been concentrated by filtration of the permeated water by passing through the raw water flow path of each membrane element 10 flows out through a concentrated water flow outlet 44.

Into the pressure vessel 40, a plurality of membrane elements 10 are inserted in a direction from the opening 43 formed at one end of the pressure vessel 40 to the opening 43 formed at the other end of the pressure vessel 40. The membrane elements 10 inserted in this manner into the pressure vessel 40 are arranged coaxially relative to the pressure vessel 40 when the membrane elements 10 located at both ends thereof are held by a vessel cover 41.

In this example, the insertion direction W of the membrane elements 10 relative to the pressure vessel 40 is the same as the flow passage direction of the liquid within the pressure vessel 40. In other words, the membrane elements 10 are inserted into the pressure vessel 40 in a direction from the end at which the raw water flow inlet 48 is formed to the end at which the permeated water flow outlet 46 and the concentrated water flow outlet 44 are formed in the pressure vessel 40. However, the present invention is not limited to such a construction, so that the insertion direction W of the membrane elements 10 relative to the pressure vessel 40 may be a direction opposite to the flow passage direction of the liquid within the pressure vessel 40.

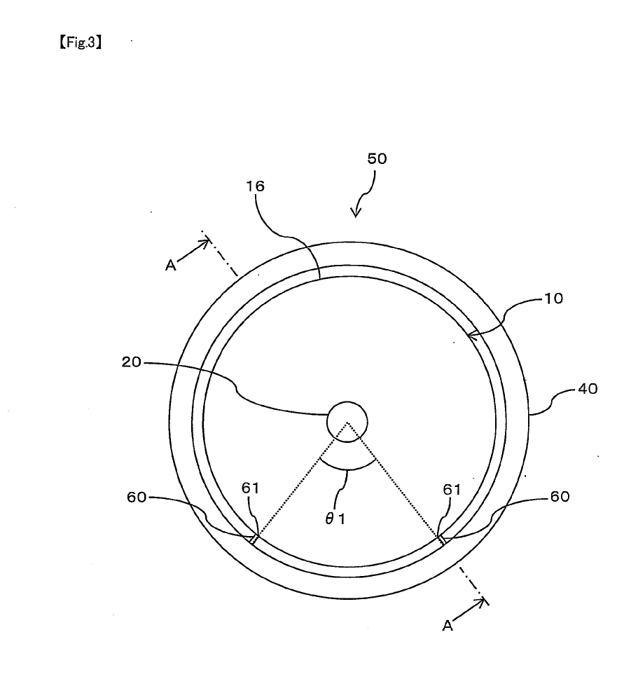

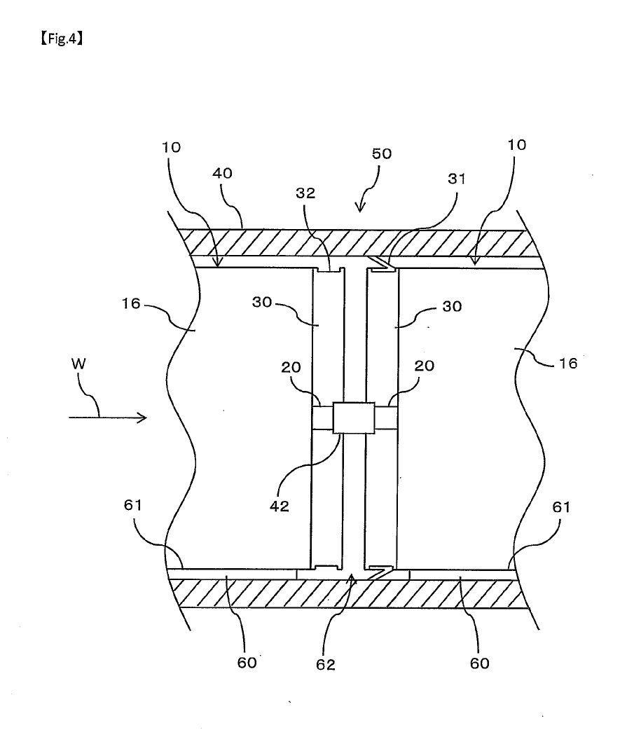

FIG. 3 is a cross-sectional view illustrating an internal construction when the membrane elements 10 are inserted into the pressure vessel 40 in a membrane filtration apparatus 50 equipped with a pressure vessel for a membrane element according to the first embodiment of the present invention. Also, FIG. 4 is a cross-sectional view of the membrane filtration apparatus 50 taken along line A-A shown in FIG. 3.

Referring to FIGS. 3 and 4, two rails 60 extending along the insertion direction W of the membrane elements 10 are formed in the pressure vessel 40. These rails 60 are each made with a protrusion that protrudes from the inner circumferential surface of the pressure vessel 40 in a radial direction of the pressure vessel 40. By these rails 60, a step difference is formed on the inner circumferential surface of the pressure vessel 40, and a ridge line 61 extending linearly along the insertion direction W of the membrane elements 10 is formed at the tip end of the rails 60.

The angle θ1 that the two rails 60 form relative to the central axial line of the pressure vessel 40 can be set to be an arbitrary angle smaller than 180° as long as the two rails 60 are both constructed to be arranged on the lower side within the pressure vessel 40. However, in view of frictional resistance reduction and stability of the membrane elements 10, the angle θ1 is preferably 135° or smaller, more preferably 90° or smaller. Also, in order that the friction reduction effect is effectively produced even when the vertical axis of the membrane elements 10 is shifted within the pressure vessel 40, the angle θ1 is preferably 20° or larger, more preferably 45° or larger. Also, the height of each rail 60 can be set to be an arbitrary height within a range such that the distance from the tip end (ridge line 61) of each rail 60 to the inner circumferential surface of the pressure vessel 40 that opposes to the tip end with the central axial line interposed therebetween is larger than the outer diameter of the membrane elements 10.

Each rail 60 is formed from one end to the other end of the pressure vessel 40. In this example, as shown in FIG. 4, because one or plural recesses 62 are formed in the midway of each rail 60, the ridge line 61 is partially segmented by the recesses 62. The bottom surface of each recess 62 is positioned in the same plane as the inner circumferential surface of the pressure vessel 40, whereby the rails 60 are divided into plural parts with each recess 62 interposed therebetween.

Each recess 62 is formed at a part positioned at both ends of each membrane element 10 and opposing each end member 30 mounted on the two ends. Referring to FIG. 4, at a position opposite to the end members 30 respectively mounted on the ends of the membrane elements 10 opposing each other, a recess 62 is formed to be continuous between these opposing ends. That is, the end members 30 respectively mounted on the opposing ends oppose to one recess 62. In this manner, by forming a recess 62 at a position opposite to the end of each membrane element 10 in the rail 60, the end of the membrane element 10 inserted into the pressure vessel 40 can be prevented from abutting onto the ridge line 61 of the rail 60.

In the present embodiment, the membrane elements 10 can be inserted into the pressure vessel 40 so as to be in a sliding contact onto the ridge line 61 of the rails 60 formed on the inner circumferential surface of the pressure vessel 40. Therefore, unlike conventional ways, the frictional resistance can be reduced as compared with a construction in which most of the lower part on the outer circumferential surface of the membrane element is in a sliding contact with the inner circumferential surface of the pressure vessel, so that the membrane element 10 can be easily mounted onto the pressure vessel 40. In particular, in the present embodiment, the membrane element 10 can be easily mounted onto the pressure vessel 40 with a simple construction such as forming a rail 60 within the pressure vessel 40.

Here, in each end member 30, a circumferential groove 32 is formed on the outer circumferential surface thereof, and an annular sealing member 31 is fitted into the circumferential groove 32, if needed. Each sealing member 31 has a V-shaped cross-sectional shape that is folded in a direction opposite to the insertion direction W of the membrane element 10. Therefore, at the time of inserting the membrane element 10 into the pressure vessel 40, the part of each sealing member 31 that opposes the rail 60 is in a sliding contact onto the rail 60 (onto the ridge line 61) in a compressed state. When the membrane element 10 is inserted up to a position at which each sealing member 31 opposes the recess 62, each sealing member 31 is restored within the recess 62 as shown in FIG. 4, and the tip end thereof abuts against the inner circumferential surface (the bottom surface of the recess 62) of the pressure vessel 40.

In the present embodiment, the recess 62 is formed at a position opposing the end of the membrane element 10 in the rail 60. Therefore, by disposing the sealing member 31 within the recess 62, the sealing member 31 can be allowed to abut against the inner circumferential surface of the pressure vessel 40 in a good manner, whereby a sealing property can be ensured.

However, the present invention is not limited to a construction in which the recess 62 formed in the rail 60 is formed at all the positions opposing the end of the membrane element 10 as shown above, so that the recess 62 may be formed at least at a part that opposes the sealing member 31 held by each end member 30. Therefore, it is possible to adopt a construction in which the recess 62 is formed only at a part of the rail 60 that opposes the end member 30 by which the sealing member 31 is held, or it is possible to adopt a construction in which the recess 62 is formed only at a part that opposes the sealing member 31 in the end member 30 by which this sealing member 31 is held.

Also, the present invention is not limited to a construction in which each rail 60 protrudes from the inner circumferential surface of the pressure vessel 40 in a radial direction of the pressure vessel 40, so that it is possible to adopt a construction in which each rail 60 protrudes upwards. In this case, it is possible to adopt a construction in which the rails 60 extend in parallel with each other. Further, the number of rails 60 is not limited to two, so that three or more rails 60 may be provided.

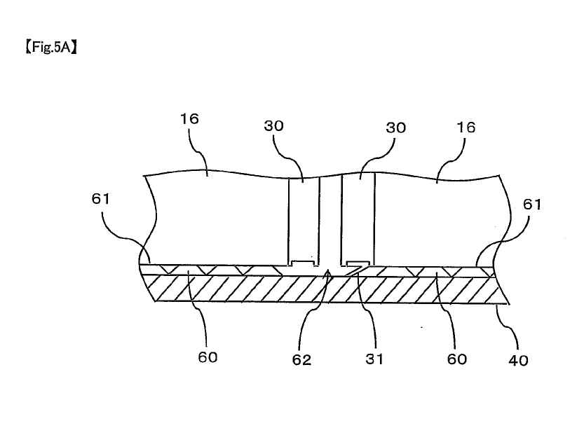

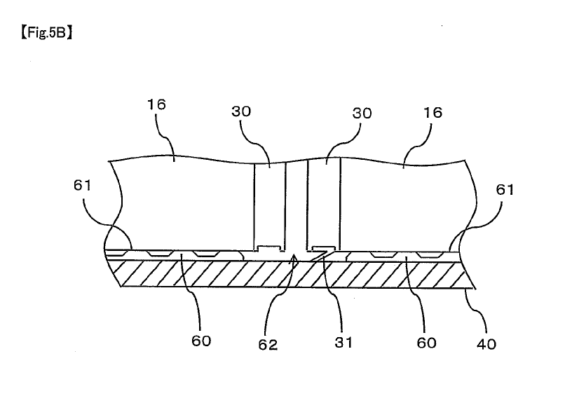

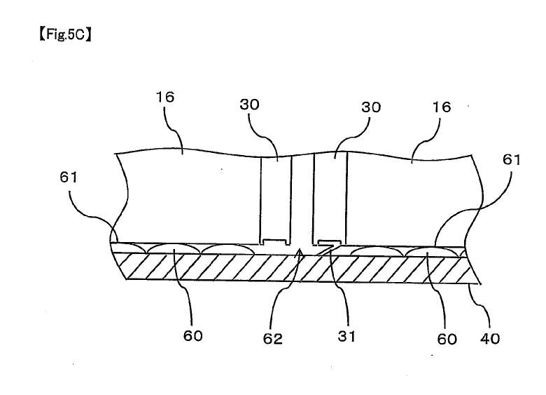

FIG. 5A is a partial cross-sectional view of a membrane filtration apparatus 50 showing a first modified example of a protrusion. In this first modified example, the ridge line 61 formed at the tip end of the rail 60 serving as a protrusion not only is segmented by the recess 62 at positions opposing the two ends of each membrane element 10 as in the example of FIG. 4 but also is segmented by forming a plurality of recesses at other positions opposing the membrane element 10 such as positions opposing the membrane member 16, for example.

Specifically, by forming triangular recesses in the rail 60 at a predetermined interval, the rail 60 is formed to have a construction in which trapezoidal projections are arranged and disposed continuously without an interval. However, the rail 60 is not limited to a construction in which a plurality of trapezoidal projections are arranged and disposed, so that it is possible to adopt a construction in which a plurality of projections having another polygonal shape such as triangular, square, or rectangular projections are arranged and disposed.

FIG. 5B is a partial cross-sectional view of a membrane filtration apparatus 50 showing a second modified example of a protrusion. In this second modified example also, the ridge line 61 formed at the tip end of the rail 60 serving as a protrusion not only is segmented by the recess 62 at positions opposing the two ends of each membrane element 10 as in the example of FIG. 4 but also is segmented by forming a plurality of recesses at other positions opposing the membrane element 10 such as positions opposing the membrane member 16, for example.

This second modified example is similar to the example of FIG. 5A in that the rail 60 includes a plurality of trapezoidal projections; however, the second modified example is different from the example of FIG. 5A in that the plurality of those projections are arranged by being spaced apart from each other. Specifically, by forming trapezoidal recesses at a predetermined interval in the rail 60, the rail 60 is formed to have a construction in which a plurality of trapezoidal projections are arranged and disposed by being spaced apart from each other. However, the rail 60 is not limited to a construction in which a plurality of trapezoidal projections are arranged and disposed, so that it is possible to adopt a construction in which a plurality of projections having another polygonal shape such as triangular, square, or rectangular projections are arranged and disposed.

FIG. 5C is a partial cross-sectional view of a membrane filtration apparatus 50 showing a third modified example of a protrusion. In this third modified example also, the ridge line 61 formed at the tip end of the rail 60 serving as a protrusion not only is segmented by the recess 62 at positions opposing the two ends of each membrane element 10 as in the example of FIG. 4 but also is segmented by forming a plurality of recesses at other positions opposing the membrane element 10 such as positions opposing the membrane member 16, for example.

This third modified example is similar to the example of FIG. 5A in that the rail 60 is made of a plurality of projections; however, the third modified example is different from the example of FIG. 5A in that the plurality of those projections are formed to have a circular arc shape instead of a polygonal shape. Specifically, by forming circular arc-shaped recesses in the rail 60 at a predetermined interval, the rail 60 is formed to have a construction in which circular arc-shaped projections are arranged and disposed continuously without an interval. However, the rail 60 is not limited to a construction in which a plurality of projections are arranged and disposed continuously without an interval, so that it is possible to adopt a construction in which a plurality of projections are arranged and disposed by being spaced apart from each other.

In the modified examples of the rail 60 such as shown in FIGS. 5A to 5C, the interval between the plural projections constituting the rail 60 is preferably shorter than the length by which those projections are in contact with the membrane element 10. Also, it is preferable that at least two rails 60 having a construction such as described above are provided in the pressure vessel 40, and it is preferable to adopt a construction in which those rails 60 are arranged in parallel and extend in parallel with each other.

### Second Embodiment

In the first embodiment, description has been given of a construction in which the rail 60 is directly formed on the inner circumferential surface of the pressure vessel 40. In contract, a second embodiment is different from the first embodiment in that a groove serving as a recess is formed on the inner circumferential surface of the pressure vessel 40, and rails are formed in the groove.

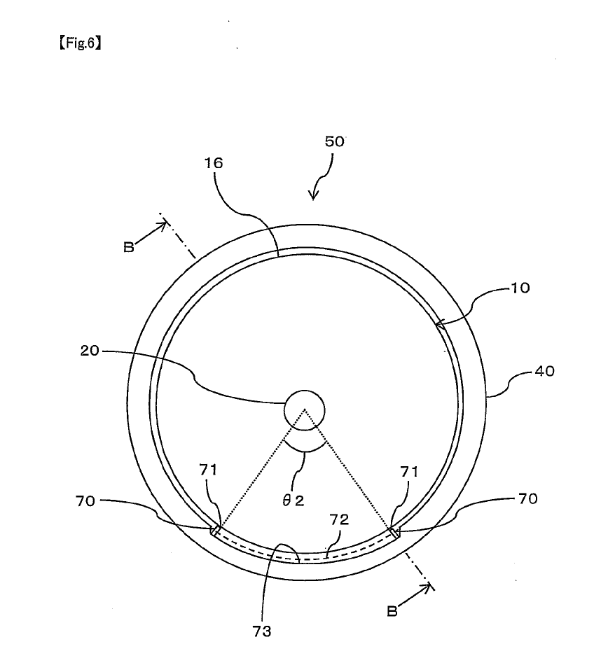

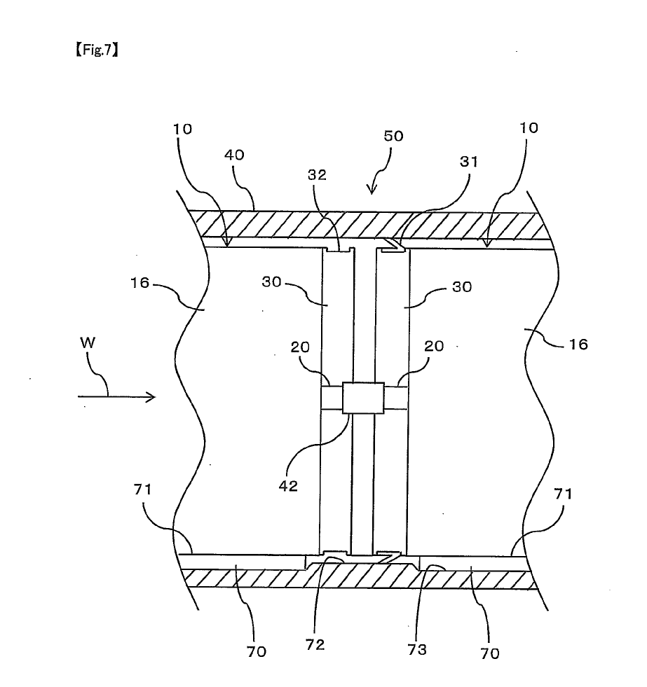

FIG. 6 is a cross-sectional view illustrating an internal construction when the membrane element 10 is inserted into a pressure vessel 40 in a membrane filtration apparatus 50 equipped with the pressure vessel 40 for a membrane element according to the second embodiment of the present invention. Also, FIG. 7 is a cross-sectional view of the membrane filtration apparatus 50 taken along line B-B shown in FIG. 6.

Referring to FIGS. 6 and 7, a groove 73 extending along the insertion direction W of the membrane element 10 is formed on the inner circumferential surface of the pressure vessel 40, and two rails 70 extending along the insertion direction W are formed within this groove 73. These rails 70 are each made of a rib that protrudes from the bottom surface of the groove 73 in a radial direction of the pressure vessel 40. By these rails 70, a step difference is formed on the inner circumferential surface of the pressure vessel 40, and a ridge line 71 extending linearly along the insertion direction W of the membrane elements 10 is formed at the tip end of the rails 70.

The angle θ2 that the two rails 70 form relative to the central axial line of the pressure vessel 40 can be set to be an arbitrary angle smaller than 180° as long as the two rails 70 are both constructed to be arranged on the lower side within the pressure vessel 40. However, in view of frictional resistance reduction and stability of the membrane elements 10, the angle θ2 is preferably 135° or smaller, more preferably 90° or smaller. Also, in order that the friction reduction effect is effectively produced even when the vertical axis of the membrane elements 10 is shifted within the pressure vessel 40, the angle θ2 is preferably 20° or larger, more preferably 45° or larger. Also, the height of each rail 70 can be set to be an arbitrary height within a range such that the distance from the tip end (ridge line 71) of each rail 70 to the inner circumferential surface of the pressure vessel 40 that opposes to the tip end with the central axial line interposed therebetween is larger than the outer diameter of the membrane elements 10.

The width of the groove 73 formed on the inner circumferential surface in the pressure vessel 40 in a direction perpendicular to the insertion direction W can be set to be an arbitrary width within a range such that each rail 70 can be formed within the groove 73. Also, the depth of the groove 73 is preferably smaller than the height of the rails 70; however, the present invention is not limited to such a depth, so that the depth may be, for example, identical to or of the same degree as the height of the rails 70.

Each rail 70 is formed from one end to the other end of the pressure vessel 40. In this example, in the same manner as in the first embodiment, as shown in FIG. 7, because one or plural recesses are formed in the midway of each rail 70, the ridge line 71 is partially segmented by the recesses. The bottom surface of each recess is a protrusion 72 that protrudes from the bottom surface of the groove 73, whereby the rails 70 are divided into plural parts with each protrusion 72 interposed therebetween. Here, the top surface of each protrusion 72 is positioned in the same plane as the inner circumferential surface of the pressure vessel 40.

The relative position of forming each recess relative to each membrane element 10 as well as the shape of each sealing member 31 and the mode of mounting the sealing member 31 onto each end member 30 are the same as those in the first embodiment, so that the description thereof will not be given by denoting with the same reference numerals in the figures.

In the present embodiment, the membrane elements 10 can be inserted into the pressure vessel 40 so as to be in a sliding contact onto the ridge line 71 of the rails 70 formed on the inner circumferential surface (bottom surface of the groove 73) of the pressure vessel 40. Therefore, unlike conventional ways, the frictional resistance can be reduced as compared with a construction in which most of the lower part on the outer circumferential surface of the membrane element is in a sliding contact with the inner circumferential surface of the pressure vessel, so that the membrane elements 10 can be easily mounted onto the pressure vessel 40. Also, a recess is formed at a position opposing the end of the membrane element 10 in the rail 70. Therefore, by disposing the sealing member 31 within the recess, the sealing member 31 can be allowed to abut against the inner circumferential surface (top surface of the protrusion 72) of the pressure vessel 40 in a good manner, whereby a sealing property can be ensured.

Also, in the present embodiment, the end of the membrane element 10 inserted into the pressure vessel 40 can be brought close to the protrusion 72 formed in the groove 73. That is, the protrusion 72 is formed at a position in the groove 73 that opposes the end of the membrane element 10. Therefore, by disposing a sealing member 31 at a position that opposes the protrusion 72, the sealing member 31 can be made to abut in a good manner against the inner circumferential surface of the pressure vessel 40 (the top surface of the protrusion 72), whereby a sealing property can be ensured.

In particular, in the present embodiment, the rail 70 can be easily added to the membrane element 10 and the pressure vessel 40 having a constant shape. That is, when the rail is directly formed on the inner circumferential surface of the pressure vessel 40, there are cases in which the outer diameter of the membrane element 10 must be made smaller or the inner diameter of the pressure vessel 40 must be made larger in relation to the clearance between the outer circumferential surface of the membrane element 10 and the inner circumferential surface of the pressure vessel 40. However, by forming a groove 73 in the inner circumferential surface of the pressure vessel 40 and forming a rail 70 within the groove 73 as in the present embodiment, the membrane element 10 can be easily mounted on the pressure vessel 40 without changing the sizes of the membrane element 10 and the pressure vessel 40 from conventional ones.

### Third Embodiment

In the first and second embodiments, description has been made on a construction in which the membrane element 10 is inserted into the pressure vessel 40 so as to be in a sliding contact onto the ridge line 61, 71 of the rail 60, 70 formed on the inner circumferential surface of the pressure vessel 40. In contrast, the third embodiment is different in that a groove serving as a recess is formed on the inner circumferential surface of the pressure vessel 40, and the membrane element 10 is inserted into the pressure vessel 40 so as to be in a sliding contact onto the ridge line formed by the groove.

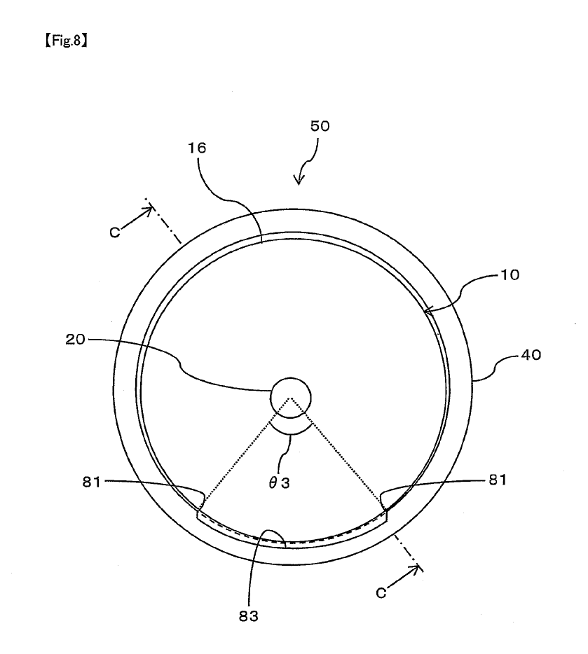

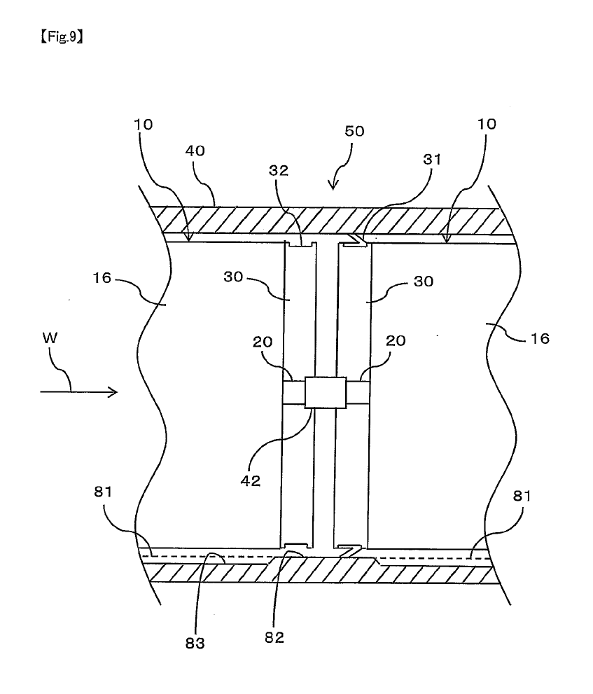

FIG. 8 is a cross-sectional view illustrating an internal construction when the membrane element 10 is inserted into the pressure vessel 40 in a membrane filtration apparatus 50 equipped with the pressure vessel 40 for a membrane element according to the third embodiment of the present invention. Also, FIG. 9 is a cross-sectional view of the membrane filtration apparatus 50 taken along line C-C shown in FIG. 8.

Referring to FIGS. 8 and 9, a groove 83 that extends along the insertion direction W of the membrane element 10 is formed on the inner circumferential surface of the pressure vessel 40. By this groove 83, a step difference is formed on the inner circumferential surface of the pressure vessel 40, and a ridge line 81 that extends linearly along the insertion direction W of the membrane element 10 is formed at both edges of the groove 83 in the width direction.

The angle θ3 that the two edges of the groove 83 (ridge lines 81) form relative to the central axial line of the pressure vessel 40 can be set to be an arbitrary angle smaller than 180° as long as the two edges are both constructed to be arranged on the lower side within the pressure vessel 40. However, in view of frictional resistance reduction and stability of the membrane elements 10, the angle θ3 is preferably 135° or smaller, more preferably 90° or smaller. Also, in order that the friction reduction effect is effectively produced even when the vertical axis of the membrane elements 10 is shifted within the pressure vessel 40, the angle θ3 is preferably 20° or larger, more preferably 45° or larger.

The groove 83 is formed from one end to the other end of the pressure vessel 40. In this example, as shown in FIG. 9, because one or plural protrusions 82 are formed in the midway of the groove 83, the ridge line 81 is partially segmented by the protrusions 82. Here, the top surface of each protrusion 82 is positioned in the same plane as the inner circumferential surface of the pressure vessel 40. The relative position of forming each protrusion 82 relative to each membrane element 10 as well as the shape of each sealing member 31 and the mode of mounting the sealing member 31 onto each end member 30 are the same as in the second embodiment, so that the description thereof will not be given by denoting with the same reference numerals in the figures.

In the present embodiment, the membrane elements 10 can be inserted into the pressure vessel 40 so as to be in a sliding contact onto the ridge line 81 of the groove 83 formed on the inner circumferential surface of the pressure vessel 40. Therefore, unlike conventional ways, the frictional resistance can be reduced as compared with a construction in which most of the lower part on the outer circumferential surface of the membrane element is in a sliding contact with the inner circumferential surface of the pressure vessel, so that the membrane elements 10 can be easily mounted onto the pressure vessel 40. Also, a protrusion 82 is formed at a position opposing the end of the membrane element 10 in the groove 83. Therefore, by disposing the sealing member 31 within the protrusion 82, the sealing member 31 can be allowed to abut against the inner circumferential surface (top surface of the protrusion 82) of the pressure vessel 40 in a good manner, whereby a sealing property can be ensured.

In particular, in the present embodiment, the membrane elements 10 can be easily mounted-onto the pressure vessel 40 by using the ridge line 81 formed by the groove 83 without separately forming a rail 60, 70 as in the first or second embodiment. Also, by a construction in which the ridge line 81 formed by the groove 83 is used, the sizes of the membrane element 10 and the pressure vessel 40 need not be changed from conventional ones.

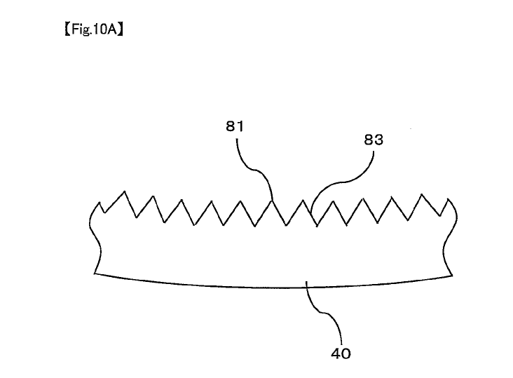

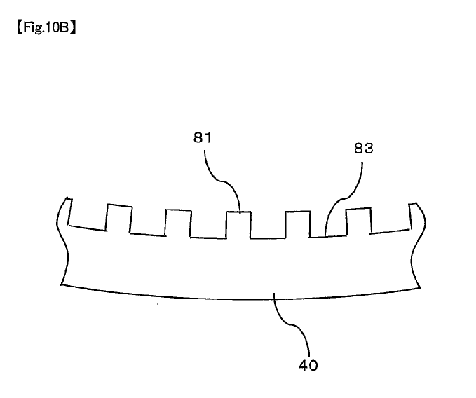

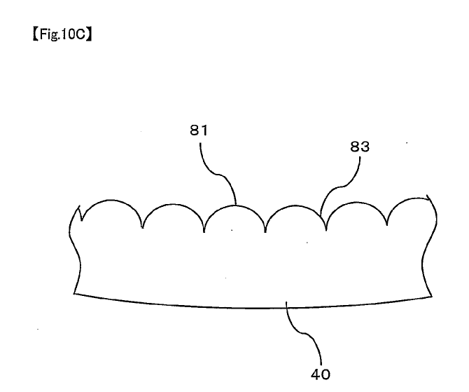

FIG. 10A is a partial cross-sectional view of a pressure vessel 40 showing a first modified example of a recess. This first modified example does not adopt a construction in which, as in the example of FIG. 8, only one groove 83 is formed as a recess, but adopts a construction in which a plurality of grooves 83 extending along the insertion direction W of the membrane element 10 are arranged in parallel and extend in parallel with each other.

Specifically, a plurality of grooves 83 having a triangular cross-section are formed to extend along the insertion direction W, whereby projections having a triangular cross-section and extending along the insertion direction W are formed to be arranged continuously in the circumferential direction without an interval. A ridge line 81 extending along the insertion direction W is formed at the tip end of the projection. However, the projections are not limited to a construction of being formed to be arranged continuously in the circumferential direction without an interval, so that it is possible to adopt a construction in which a plurality of projections are formed to be spaced apart from each other in the circumferential direction.

FIG. 10B is a partial cross-sectional view of a pressure vessel 40 showing a second modified example of a recess. This second modified example also does not adopt a construction in which, as in the example of FIG. 8, only one groove 83 is formed as a recess, but adopts a construction in which a plurality of grooves 83 extending along the insertion direction W of the membrane element 10 are arranged in parallel and extend in parallel with each other.

This second modified example is different from the example of FIG. 10A in that the grooves 83 are formed to have a square shape or a rectangular shape instead of a triangular shape and that projections having a square shape or a rectangular shape and extending along the insertion direction W are formed and arranged to be spaced apart in the circumferential direction. A ridge line 81 extending along the insertion direction W is formed at the tip end of the projection. However, the projections are not limited to a construction of having a square shape or a rectangular shape, so that it is possible to adopt a construction in which the projections are formed to have another polygonal shape such as a trapezoidal shape. In this case, the projections are not limited to a construction of being formed to be spaced apart from each other in the circumferential direction, so that it is possible to adopt a construction of being formed to be arranged continuously in the circumferential direction without an interval.

FIG. 10C is a partial cross-sectional view of a pressure vessel 40 showing a third modified example of a recess. This third modified example also does not adopt a construction in which, as in the example of FIG. 8, only one groove 83 is formed as a recess, but adopts a construction in which a plurality of grooves 83 extending along the insertion direction W of the membrane element 10 are arranged in parallel and extend in parallel with each other.

This third modified example is different from the example of FIG. 10A in that the grooves 83 are formed to have a circular arc shape instead of a triangular shape. Specifically, a plurality of grooves 83 having a circular arc cross-section are formed to extend along the insertion direction W, whereby projections having a circular arc cross-section and extending along the insertion direction W are formed to be arranged continuously in the circumferential direction without an interval. A ridge line 81 extending along the insertion direction W is formed at the tip end of the projection. However, the projections are not limited to a construction of being formed to be arranged continuously in the circumferential direction without an interval, so that it is possible to adopt a construction in which a plurality of projections are formed to be spaced apart from each other in the circumferential direction.

In the modified examples of the grooves 83 such as shown in FIGS. 10A to 10C, description has been given of a construction in which the projections formed by the grooves 83 extend linearly along the insertion direction W. However, by combining a construction such as shown in FIGS. 10A to 10C with a construction such as shown in FIGS. 5A to 5C, it is possible to adopt a construction in which the ridge line 81 formed at the tip end of the projection is segmented by a recess along the insertion direction W. Also, an opening for discharging water (drain water discharging hole) can be formed at the bottom surface of the grooves 83.

In the embodiments, description has been given of a construction in which a recess or protrusion is formed by the rail 60, 70 or groove 83. However, the present invention is not limited to such a construction, so that a recess or protrusion having various other shapes can be formed on the inner circumferential surface of the pressure vessel 40 as long as it is a recess or protrusion formed on the inner circumferential surface of the pressure vessel 40 so that the ridge line may extend along the insertion direction W of the membrane element 10. Here, the recess or protrusion is not limited to a shape made of a bent shape where the ridge line extends along the bent portion such as in the embodiments, so that the recess or protrusion may be made, for example, of a curved shape. When the recess or protrusion is made of a curved shape in this manner, the ridge line extends along the part of the curved surface that is in contact with the membrane element 10.

Also, in the embodiments, description has been given of a construction in which a plurality of membrane elements 10 are inserted into the pressure vessel 40. However, the present invention is not limited to such a construction, so that the present invention can be applied even to a construction in which one membrane element 10 is inserted into the pressure vessel 40.

Further, in the embodiments, description has been given of a case in which raw water such as waste water or sea water is filtered with use of the membrane filtration apparatus 50. However, the present invention is not limited to such a construction, so that the present invention can be applied to a process of separating gas or liquid using a construction similar to the membrane filtration apparatus 50 or the like process.

In the embodiments, the process of forming a recess or protrusion by the rail 60, 70 or groove 83 on the inner circumferential surface of the pressure vessel 40 constitutes a frictional resistance reduction process for reducing the frictional resistance between the membrane elements 10 inserted into the pressure vessel 40 and the inner circumferential surface of the pressure vessel 40. That is, by forming a recess or protrusion on the inner circumferential surface of the pressure vessel 40, the contact area between the membrane elements 10 inserted into the pressure vessel 40 and the inner circumferential surface of the pressure vessel 40 decreases and, as a result thereof, the frictional resistance can be reduced.

According to such a construction, the membrane elements 10 can be inserted into the pressure vessel 40 so as to be in a sliding contact with the inner circumferential surface of the pressure vessel 40 that has been subjected to a frictional resistance reduction process, whereby the frictional resistance can be reduced, and the membrane elements 10 can be easily mounted on the pressure vessel 40. However, the frictional resistance reduction process is not limited to a mode such as described in the above embodiments, so that other modes such as those described in the following embodiments may be adopted as well.

Also, in the embodiments, since the rail 60, 70 or the groove 83 is formed intermittently in the insertion direction W of the membrane element 10, the sealing member 31 disposed on the end member 30 of the membrane element 10 can be disposed at a stable position and can be let to function effectively, whereby the stability at the time of fixing and at the time of using the membrane element 10 can be raised. Also, since the rail 60, 70 or the groove 83 is formed linearly in the insertion direction W of the membrane element 10, the resistance can be efficiently reduced, whereby the efficiency at the time of mounting the membrane element 10 can be raised.

### Fourth Embodiment

In the first to third embodiments, description has been given of a construction in which a recess or protrusion is formed by the rail 60, 70 or the groove 83 on the inner circumferential surface of the pressure vessel 40. In contrast, the fourth embodiment is different in that a rotor that rotates in contact with the membrane element 10 is disposed on the inner circumferential surface of the pressure vessel 40. The rotor may constitute a protrusion that protrudes over the inner circumferential surface of the pressure vessel 40 or may be a construction of not protruding from the inner circumferential surface of the pressure vessel 40.

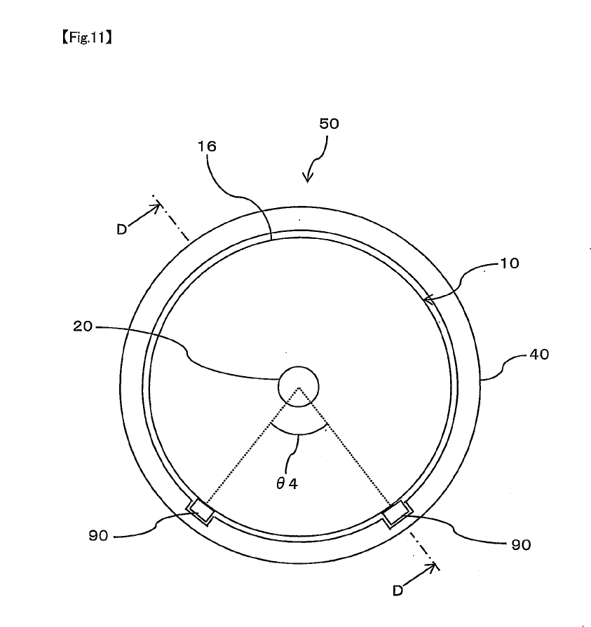

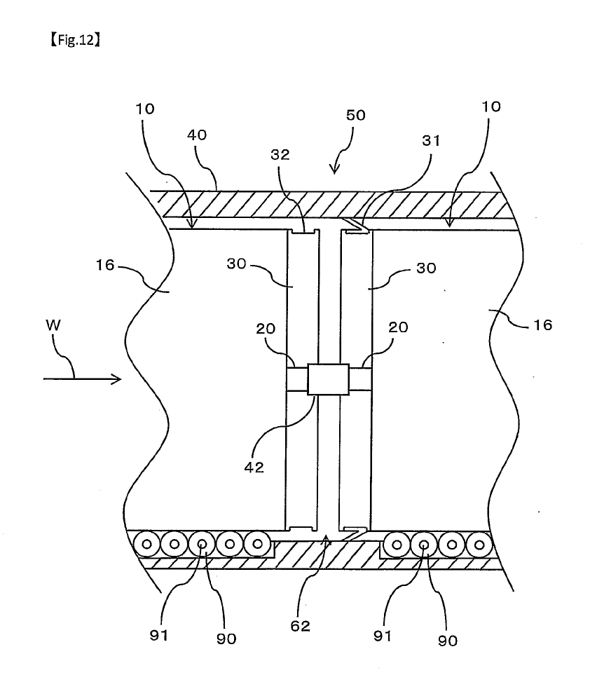

FIG. 11 is a cross-sectional view illustrating an internal construction when the membrane element 10 is inserted into the pressure vessel 40 in a membrane filtration apparatus 50 equipped with the pressure vessel 40 for a membrane element according to the fourth embodiment of the present invention. Also, FIG. 12 is a cross-sectional view of the membrane filtration apparatus 50 taken along line D-D shown in FIG. 11.

Referring to FIGS. 11 and 12, a plurality of rollers 90 capable of rotating with the center located at the rotation shaft 91 are disposed on the inner circumferential surface of the pressure vessel 40. Each rotation shaft 91 extends in the circumferential direction perpendicular to the insertion direction W of the membrane element 10. The rollers 90 are disposed to be orderly arranged in two rows along the insertion direction W of the membrane element 10. In each row, adjacent rollers 90 may have outer circumferential surfaces that are in contact with each other, or may have outer circumferential surfaces that are spaced apart by a certain amount.

In this example, a recess is formed on the inner circumferential surface of the pressure vessel 40, and the rollers 90 are disposed within the recess. An opening for discharging water (drain water discharging hole) can be formed at the bottom surface of the recess. However, the present invention is not limited to a construction in which the rollers 90 are disposed within the recess, so that it is possible to adopt a construction in which the rollers 90 are mounted without forming a recess on the inner circumferential surface of the pressure vessel 40.

The angle θ4 that the rollers 90 of each row form relative to the central axial line of the pressure vessel 40 can be set to be an arbitrary angle smaller than 180° as long as the rollers 90 are all constructed to be arranged on the lower side within the pressure vessel 40. However, in view of frictional resistance reduction and stability of the membrane elements 10, the angle θ4 is preferably 135° or smaller, more preferably 90° or smaller. Also, in order that the friction reduction effect is effectively produced even when the vertical axis of the membrane elements 10 is shifted within the pressure vessel 40, the angle θ4 is preferably 20° or larger, more preferably 45° or larger.

The rollers 90 are disposed from one end to the other end of the pressure vessel 40. In this example, as shown in FIG. 12, the rollers 90 are not disposed at a position that opposes the end of the membrane element 10. This allows that the sealing member 31 can be made to abut in a good manner against the inner circumferential surface of the pressure vessel 40, whereby a sealing property can be ensured. The shape of each sealing member 31 and the mode of mounting the sealing member 31 onto each end member 30 are the same as in the above embodiments, so that the description thereof will not be given by denoting with the same reference numerals in the figures.

In the present embodiment, by disposing a roller 90 serving as a rotor that rotates in contact with the membrane element 10 on the inner circumferential surface of the pressure vessel 40, the frictional resistance between the inner circumferential surface and the membrane element 10 can be effectively reduced, whereby the membrane element 10 can be easily mounted onto the pressure vessel 40.

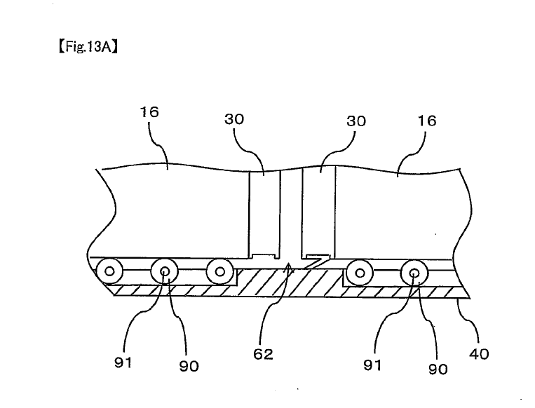

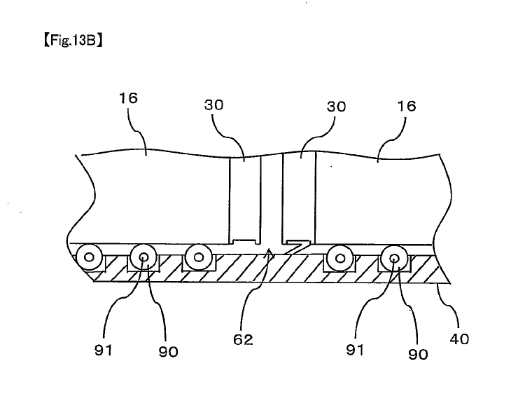

FIG. 13A is a partial cross-sectional view of a membrane filtration apparatus 50 showing a first modified example of a rotor. This first modified example does not have a construction in which adjacent rollers 90 in each row have outer circumferential surfaces that are in contact with each other or spaced apart from each other by a certain amount as in the example of FIG. 12, but adjacent rollers 90 in each row are arranged to be spaced apart from each other by a comparatively large interval. The interval is set to be, for example, a value larger than the outer diameter of each roller 90.

FIG. 13B is a partial cross-sectional view of a membrane filtration apparatus 50 showing a second modified example of a rotor. This second modified example does not have a construction in which a plurality of rollers 90 are disposed in one recess in each row as shown in FIGS. 12 and 13A, but has a construction in which, in correspondence with each roller 90, a recess is formed for housing the roller 90. The distance between the outer circumferential surfaces of adjacent rollers 90 in each row is set to be, for example, a value larger than the outer diameter of each roller 90.

In FIGS. 12, 13A, and 13B, description has been given of the roller 90 rotatable with the center located at the rotation shaft 91 as one example of a rotor that rotates in contact with the membrane element 10 inserted into the pressure vessel 40. However, particularly in a construction such as shown in FIG. 13B, the roller 90 is not limited to a construction of being mounted on the rotation shaft 91, but may have a construction that is not provided with the rotation shaft 91.

Also, the rotor is not limited to a cylindrical or columnar one such as the roller 90, but may be, for example, a ball body. The rotor may be formed with a ball body, and a structural mode such as a ball bearing may be placed. In this case, when a construction is adopted in which the rotor is rotatable in an arbitrary direction, the degree of freedom of the membrane element 10 in the pressure vessel 40 will be high and, by letting the membrane element 10 be rotatable in a direction perpendicular to the insertion direction, the deposits within the membrane can be prevented from being unevenly distributed. Also, as the rotor, various constructions can be adopted. For example, a belt may be provided together with the roller, so as to provide a construction such as a belt conveyor.

Also, the rotors are not limited to a construction of being disposed and arranged in two rows along the insertion direction W of the membrane element 10, but may have a construction of being disposed and arranged in one row or may have a construction of being disposed and arranged in three or more rows. Also, the rotors are not limited to a construction of being disposed and arranged in the insertion direction W of the membrane element 10, but may have a construction of being disposed so as to be scattered on the inner circumferential surface of the pressure vessel 40.

### Fifth Embodiment

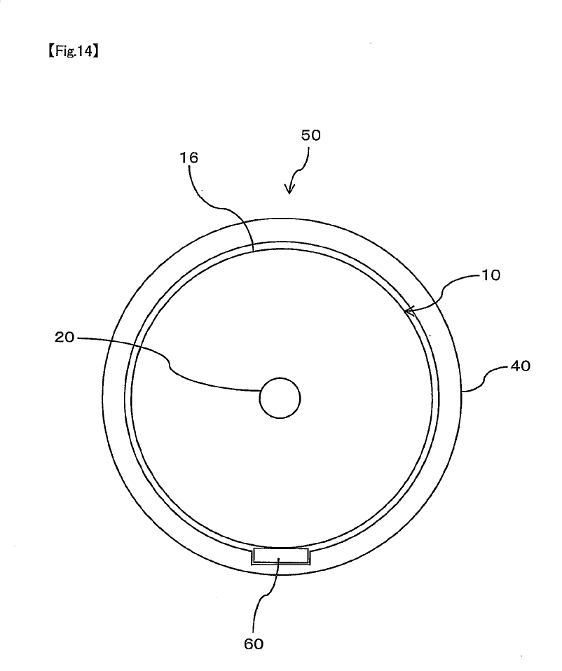

FIG. 14 is a cross-sectional view illustrating an internal construction when the membrane element 10 is inserted into the pressure vessel 40 in a membrane filtration apparatus 50 equipped with the pressure vessel 40 for a membrane element according to the fifth embodiment of the present invention. In the fourth embodiment, description has been given of a construction in which the rollers 90 serving as a rotor are disposed and arranged in two rows along the insertion direction W of the membrane element 10. In contrast, the fifth embodiment is different in that the rollers 90 are disposed and arranged in one row along the insertion direction W of the membrane element 10. The rotor may be one constituting a protrusion that protrudes over the inner circumferential surface of the pressure vessel 40 or may have a construction that does not protrude from the inner circumferential surface of the pressure vessel 40. With a construction in which the rotor is provided as described above, a motor power source such as at least one motor may be provided in the movable part so as to provide a help at the time of insertion or to make the insertion automatic.

### Sixth Embodiment

In the first to fifth embodiments, description has been given of a construction in which a process of providing a rail, groove, or rotor on the inner circumferential surface of the pressure vessel 40 is performed as a frictional resistance reduction process. In contrast, the sixth embodiment has a construction in which a fine unevenness such as an emboss processing, for example, is formed on the inner circumferential surface of the pressure vessel 40, a construction in which a surface treatment that raises the sliding property such as Teflon (registered trademark) treatment on the surface or metal plating process with a metal such as titanium or chromium is performed, or a construction in which a member having a higher sliding property than the inner circumferential surface of the pressure vessel 40, for example, a sliding material made of a fluororesin or a bamboo material, is fixed onto the inner circumferential surface of the pressure vessel 40, as the frictional resistance reduction process on the inner circumferential surface of the pressure vessel 40 so as to provide a recess or a protrusion on the inner circumferential surface of the pressure vessel 40.

In the present embodiment, by performing a process for reducing the frictional resistance on the inner circumferential surface of the pressure vessel 40, the frictional resistance between the inner circumferential surface and the membrane element 10 can be effectively reduced, whereby the membrane element 10 can be easily mounted onto the pressure vessel 40.

1. A pressure vessel for a membrane element into which the membrane element is inserted through one open end, wherein an inner circumferential surface of the pressure vessel is subjected to a frictional resistance reduction process that reduces a frictional resistance between the membrane element inserted into the pressure vessel and the inner circumferential surface when the membrane element is inserted.

2. The pressure vessel for a membrane element according to claim 1, wherein the frictional resistance reduction process is intermittently performed in a direction of inserting the membrane element.

3. The pressure vessel for a membrane element according to claim 1, wherein the frictional resistance reduction process is linearly performed in a direction of inserting the membrane element.

4. The pressure vessel for a membrane element according to claim 1, wherein the frictional resistance reduction process is providing a recess or a protrusion for reducing a contact area to the membrane element on the inner circumferential surface of the pressure vessel.

5. The pressure vessel for a membrane element according to claim 4, wherein at least one ridge line that is brought into contact with the membrane element at the recess or protrusion extends along the direction of inserting the membrane element.

6. The pressure vessel for a membrane element according to claim 4, wherein at least one protrusion that is brought into contact with the membrane element is further provided on a bottom surface of the recess.

7. The pressure vessel for a membrane element according to any one of claim 1, wherein the frictional resistance reduction process is providing a rotor on the inner circumferential surface of the pressure vessel.

8. The pressure vessel for a membrane element according to claim 1, wherein the frictional resistance reduction process is fixing a member having a higher sliding property than the inner circumferential surface of the pressure vessel.

9. The pressure vessel for a membrane element according to claim 1, wherein the membrane element is a cylindrical spiral-type membrane element in which a plurality of reverse osmosis membranes, a feed side flow path material, and a permeate side flow path material in a laminated state are wound around a core tube.

10. A membrane filtration apparatus equipped with a pressure vessel for a membrane element according to claim 1.

11. A method for manufacturing a membrane filtration apparatus, wherein a membrane element is mounted onto an inside of a pressure vessel while bringing the membrane element into contact with a part of an inner circumferential surface of the pressure vessel that has been subjected to a frictional resistance reduction process.

12. The pressure vessel for a membrane element according to claim 5, wherein at least one protrusion that is brought into contact with the membrane element is further provided on a bottom surface of the recess.

13. A pressure vessel for a membrane element into which the membrane element is inserted through one open end, said vessel comprising:
an internal chamber that accommodates a membrane element; and
an inner circumferential surface of the pressure vessel that has been subjected to a frictional resistance reduction process that reduces a frictional resistance between the membrane element inserted into the pressure vessel and the inner circumferential surface when the membrane element is inserted.
